(19) United States
(12) Patent Application Publication
(10) Pub. No.: US 2013/0160143 A1
(43) Pub. Date: Jun. 20, 2013

(54) PROCESSING MACHINE WITH ACCESS CONTROL VIA COMPUTER NETWORK

(71) Applicant: Siemens Aktiengesellschaft, Munchen (DE)

(72) Inventors: Carsten Hamm, Erlangen (DE); Michael Kaever, Erlangen (DE); Jens Ansgar Rosenberg, Nurnberg (DE)

(73) Assignee: Siemens Aktiengesellschaft, Munchen (DE)

(21) Appl. No.: 13/713,716

(22) Filed: Dec. 13, 2012

(30) Foreign Application Priority Data
Dec. 14, 2011 (EP) 11193437.8

(51) Int. Cl. G06F 21/62; G06F 21/31

(52) U.S. Cl. CPC G06F 21/62; G06F 21/31
USPC 726/28

(57) ABSTRACT

A control device controlling a processing machine receives from an external source initial data which includes at least identification data identifying the source of the initial data. The control device transmits the identification data via a connection to a computer network to a computer that is part of a computer cluster and receives authorization data from the computer or from another computer of the computer cluster. The control device allows or denies the user access to the internal data of the control device depending on the authorization data.

### CROSS-REFERENCES TO RELATED APPLICATIONS

This application claims the priority of European Patent Application, Serial No. 11193437.8, pursuant to 35 U.S.C. 119(a)-(d), the content of which is incorporated herein by reference in its entirety as if fully set forth herein.

### BACKGROUND OF THE INVENTION

The present invention relates to a method for operating a processing machine, such as a machine tool, a production machine or an industrial robot, which is controlled by a control device. The present invention further relates to a system program comprising machine code which is directly executable by a control device of a processing machine. The present invention further relates to a control device of a processing machine which is programmed with a system program of the aforedescribed type. The present invention further relates to a processing machine which has a control device of the aforedescribed type.

The following discussion of related art is provided to assist the reader in understanding the advantages of the invention, and is not to be construed as an admission that this related art is prior art to this invention.

Operating methods and control devices are known, wherein data is generated and modified right from the planning stage of a product that is to be manufactured through to its fabrication by a processing machine. In the prior art it is not possible or possible only with difficulty to establish who introduced which changes, and which tools (software tools) were used for this purpose.

There may be a variety of reasons for a user, a controller manufacturer or a machine manufacturer wanting to make sure that the route taken by said data is traceable or that said data is modified only by certain suitably qualified and authorized persons and software tools which, for example, must comply with specific quality conditions. The ability to track changes is made more difficult by the increasing spread of service-oriented architectures and cloud services. If a service of said type is used, there is no assurance in the prior art that the software providing the service originates from a specific vendor or meets a specific quality standard.

In the prior art, users have all the software tools that are used for generating and processing product data installed on their own computers. The vendors of the software tools are known. Generally they certify the quality management system or, as the case may be, compliance with guidelines important for the product on the basis of corresponding certificates in paper form. The actual characteristics of their products or the quality thereof can be verified only in respect of the characteristics defined in the respective guidelines with the aid of test certificates or reports.

Furthermore, identification of users is also important in the case of control devices. In this respect the requirements in terms of user authentication in the case of automation devices are different in certain aspects from those in the case of PCs. For example, automation devices are usually administered differently from PCs. Often there is even no centralized administration at all. The service situation is also another special aspect in the case of automation devices. The service engineer, who may come from an outside company, from the processing machine manufacturer for example, must be able to access the automation devices (the control device) with administrative rights. Since speed is normally of the essence in a service situation in order to bring the machine downtime to an end as quickly as possible, all delays should be avoided wherever possible in this scenario. For this reason it is common practice in the prior art either to dispense with the user identification completely in the case of control devices or else to set up shared logins/passwords for example for service personnel. Logins and passwords of said type remain unchanged for a long time. There is therefore in particular also the risk that a former employee no longer working for the manufacturer of the processing machine will access the automation device without authorization.

Within the scope of the user identification—insofar as such a mechanism is present—the control device receives initial data from an external source (specifically via a user interface). The initial data includes identification data identifying the source of the initial data, namely the user name and the associated password. The control device carries out an internal check to determine whether the user name and the password are in order. Depending on the result of the check, the control device allows the access to internal data of the control device or denies said access.

It would therefore be desirable and advantageous to obviate prior art shortcomings and to improve operation of a processing machine by making its operation more flexible and convenient, and in particular more reliable.

### SUMMARY OF THE INVENTION

According to one aspect of the present invention, the control device receives a user identification and an associated password directly from a user of the processing machine via an input device assigned to the control device. The control device then transmits the user identification and the password to a computer of a computer cluster via a connection to a computer network. The control device then receives user-specific authorization data from the computer or from a further computer of the computer cluster. The control device then checks whether the user-specific authorization data allows access to internal data of the control device, and depending on the result of the check, allows or denies access to the internal data of the control device by the user.

With this procedure, it is possible to realize a dynamic administration of access authorizations to the control device in a particularly simple manner.

According to an advantageous feature of the present invention, the user-specific authorization data may include user-specific restriction data limiting the access to the internal data and in the event that the user-specific authorization data allows the access to the internal data, the control device may limit access to the internal data in accordance with the user-specific restriction data.

According to another advantageous feature of the present invention, the control device may receive, for example, a program load command from the user; the control device may then check whether the user-specific restriction data includes a program load authorization, and depending on the result of the check, the control device may then receive an application program specified by the program load command for controlling the processing machine and store or not store the application program in a program memory of the control device.

According to another advantageous feature of the present invention, the application program may be supplied to the control device via a memory device connected locally to the control device, via a USB memory stick for example. However, as a result of the program load command, the control device may receive the application program from the computer, from the further computer or from a third computer of the computer cluster via the connection to the computer network.

According to another advantageous feature of the present invention, the control device may receive security information for the application program in addition to the application program, and transmit the security information to a computer of the computer cluster via the connection to the computer network. The control device may receive program-specific authorization data from a computer of the computer cluster, and check whether the program-specific authorization data allows execution of the application program. Depending on the result of the check, the control device may or may not store the application program.

According to another advantageous feature of the present invention, the program-specific authorization data may include program-specific restriction data limiting the execution of the application program, wherein in the event that the program-specific authorization data allows execution of the application program, the control device may control the processing machine only in accordance with the program-specific restriction data. Advantageously, the program-specific restriction data may, for example, specify the time period during which the application program may be executed. Alternatively or in addition, a restriction may exist which specifies how frequently the application program may be executed.

According to another advantageous feature of the present invention, the control device may transmit to the computer of the computer cluster via the connection to the computer network, together with the user identification and the password and/or together with the security information, a control device identification uniquely identifying the control device and/or a processing machine identification uniquely identifying the processing machine. The control device identification and/or the processing machine identification may also include a security code.

According to another aspect of the invention, a system program embodied in a non-transitory medium and including machine-readable machine code, which when read into memory of a control device of a processing machine and directly executed by the control device, causes the control device of the processing machine to execute the aforedescribed method.

According to another aspect of the invention, a control device of a processing machine is programmed with the aforedescribed system program. According to yet another aspect of the invention, a processing machine includes a control device which is programmed with the aforedescribed system program.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a processing machine and a computer network according to the present invention,

FIGS. 2 to 6 show exemplary flowcharts illustrating the process according to the present invention, and

FIG. 7 shows an exemplary identification format.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

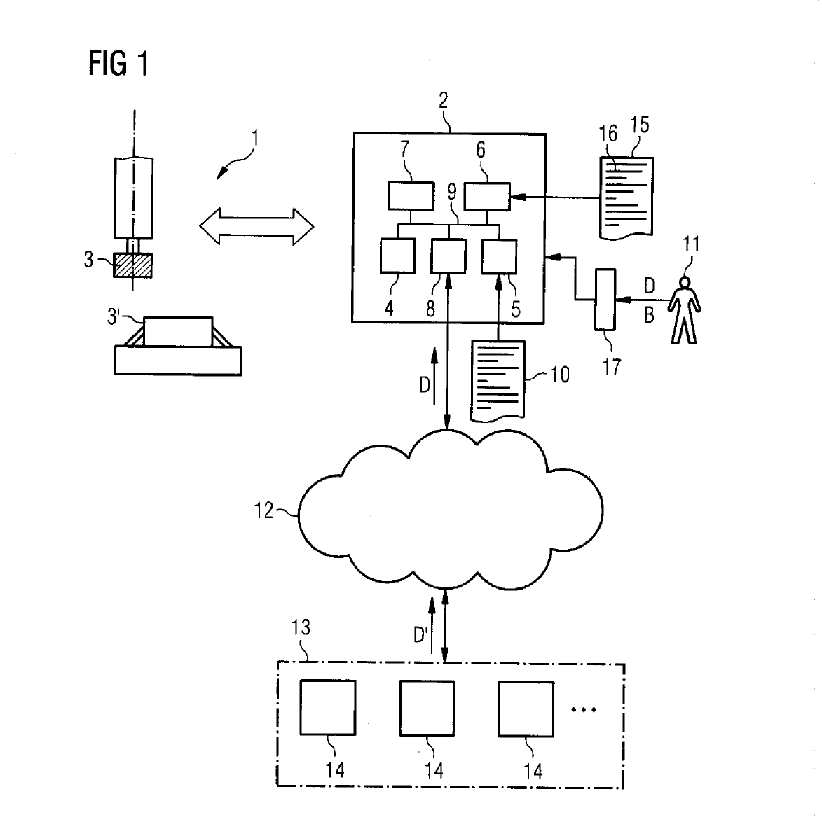

Turning now to the drawing, and in particular to FIG. 1, there is shown a processing machine 1 which is controlled by a control device 2. The processing machine 1 can in principle be embodied as any kind of processing machine, for example as a packaging machine, as a bottling plant or as a press. According to FIG. 1, the processing machine 1 is embodied as a machine tool. This is indicated in FIG. 1 by a stylized milling head 3 for machining a workpiece 3′. Alternatively the processing machine 1 can be embodied for example as a production machine or as an industrial robot.

The control device 2 is embodied as a software-programmable control device. For example, it can have a data memory 4, a program memory 5, a system memory 6, a processor 7, and a connection device 8. The cited components 4 to 8 can be interconnected via a bus 9 so that they can communicate with one another.

An application program 10 for controlling the processing machine 1 is stored in the program memory 5. The application program 10 can be modified by a user 11 of the processing machine 1. Data is stored in the data memory 4. The data can be data ascertained in the course of executing the application program 10 or data received by the processing machine 1. The control device 2 is connected to a computer network 12, for example a LAN or the WWW, via the connection device 8. Also connected to the computer network 12, inter alia, is a computer cluster 13. The computer cluster 13 includes at least one computer 14. Usually a plurality of computers 14 is present.

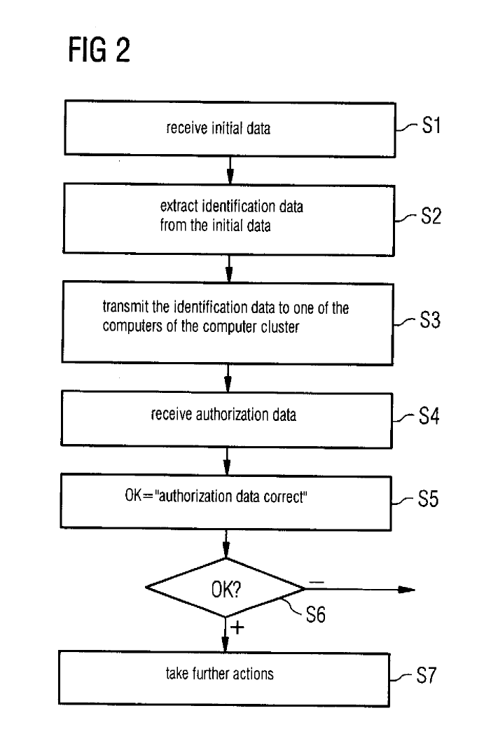

A system program 15 with which the control device 2 is programmed is stored in the system memory 6. The system program 15 includes machine code 16 which can be executed directly by the control device 2—more precisely: the processor 7 of the control device 2. The processing of the machine code 16 by the control device 2 (or, more accurately, by the processor 7 of the control device 2) causes the control device 2 to operate the processing machine 1 in accordance with an operating method which is explained in more detail below in connection with FIG. 2.

According to FIG. 2, the control device 2 receives initial data D in a step S1. The initial data D is submitted to the control device 2 from outside, i.e. not by the processing machine 1. For example, the initial data D can be submitted directly to the control device 2 by the user 11 via a corresponding input device 17. The input device 17 is assigned to the control device 2, in most cases in the form of a combined input/output device (HMI). Alternatively, the initial data D can be submitted to the control device 2 by one of the computers 14 of the computer cluster 13 via the computer network 12 and the connection device 8.

The initial data D includes at least identification data. The identification data identifies the source from which the initial data D originates, for example the corresponding computer 14 of the computer cluster 13 or the user 11. In a step S2, the control device 2 extracts—insofar as is necessary—the identification data from the initial data D. In a step S3, it then transmits the identification data to one of the computers 14 of the computer cluster 13 via the connection device 8 and the computer network 12. In so doing, the control device 2 does not need to know the physical address of the computer 14 itself. It is sufficient if the control device 2 can identify the computer 14 logically or virtually, for example by way of a URL.

The identification data is checked on the computer cluster 13 side. In accordance with the check, authorization data D′ is ascertained and transmitted to the control device 2 via the computer network 12 and the connection device 8. The control device 2 receives the authorization data D′ in a step S4.

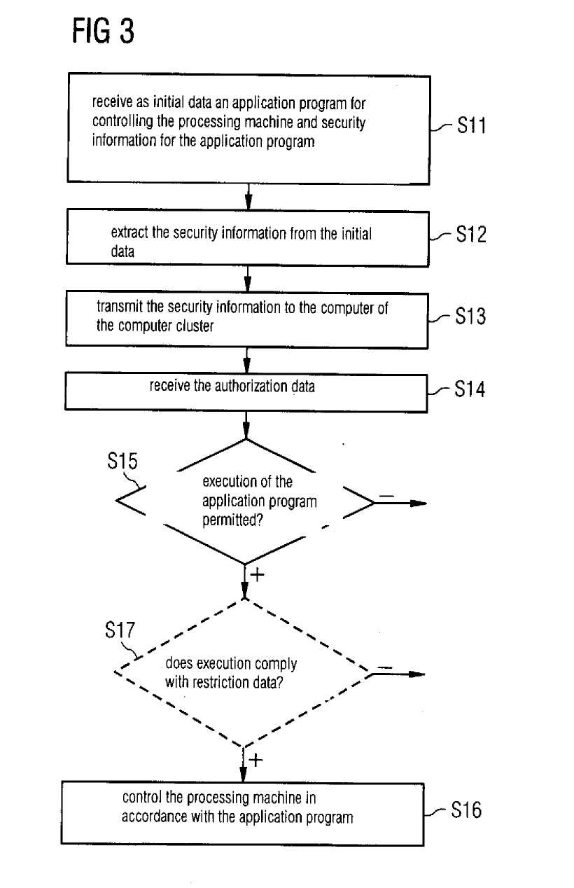

The identification data, assuming it is correct, is intended to allow further actions. In steps S5 and S6, the control device 2 therefore checks in conjunction with a logical variable OK whether the authorization data D′ is correct. Depending on the result of the check, the further actions are taken in a step S7, or are not taken. Which further actions are taken is dependent on further data which can be submitted to the control device 2 prior to, together with or after the initial data D. This will become apparent in connection with the further embodiments of FIGS. 3 to 5.

FIG. 3 shows a possible embodiment of the operating method of FIG. 2.

According to FIG. 3, the control device 2 receives in a step S11 as initial data D an application program 10 for controlling the processing machine 1 and security information for the application program 10. The security information can be for example an electronic signature or an electronic certification seal. The security information can for example guarantee that the application program 10 has been produced using a certified programming tool and/or by a certified program vendor. In a step S12, the control device 2 extracts the security information from the initial data D. In a step S13, the control device 2 transmits the security information to the corresponding computer 14 of the computer cluster 13. Steps S11 to S13 of FIG. 3 accordingly correspond to an actual embodiment of steps S1 to S3 of FIG. 2.

In a step S14—analogously to step S4 of FIG. 2—the control device 2 receives the authorization data D′ from the respective computer 14 or from a further computer 14 of the computer cluster 13.

The authorization data D′ always includes a basic code. The basic code specifies whether the execution of the application program 10 is permitted in principle or not. In a step S15, the control device 2 therefore checks using the basic code whether the execution of the application program 10 is permitted in principle. If this is not the case, the control device 2 rejects the execution of the application program 10. Otherwise, a branch can be made directly to a step S16, in which the control device 2 controls the processing machine 1 in accordance with the application program 10. Steps S14 to S16 of FIG. 3 accordingly correspond to steps S4 to S7 of FIG. 2.

In the embodiment according to FIG. 3, the authorization data D′ can include restriction data in addition to the basic code. This is only optional, however. If the restriction data is present, it limits the—in principle permitted—execution of the application program 10. For example, the restriction data can define a time by which the application program 10 may be executed. Alternatively or in addition, the restriction data can for example specify how often the application program 10 may be executed. Other restrictions are also possible.

If the restriction data is present, a step S17 is provided which is arranged between steps S15 and S16. In step S17, the control device 2 checks whether the execution of the application program 10 is in compliance with the restriction data. If this is not the case, the control device 2 rejects the execution of the application program 10.

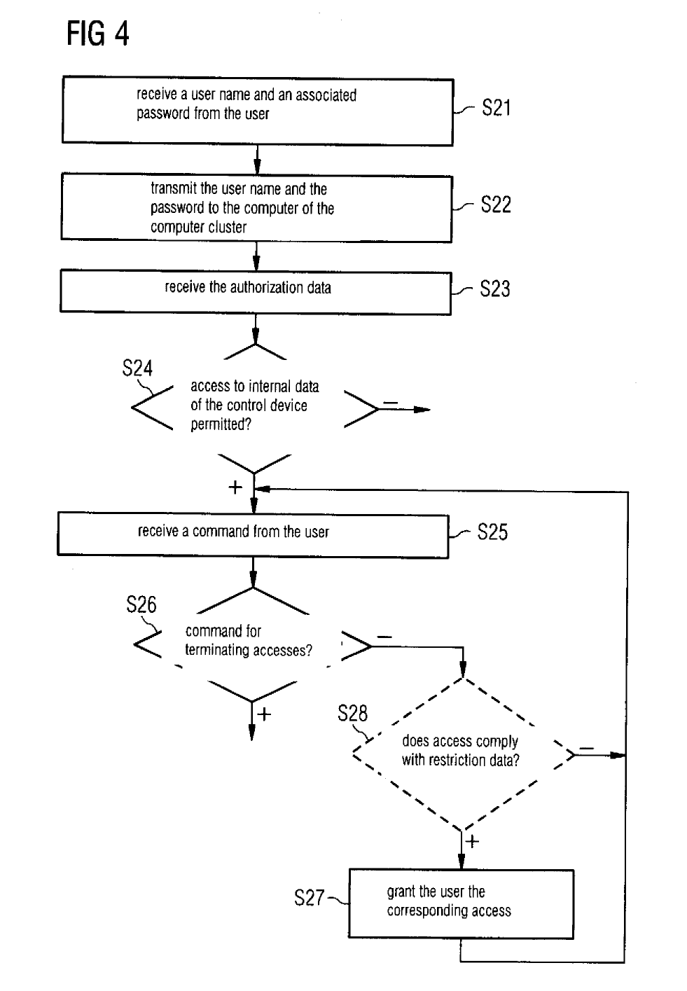

FIG. 4 shows a further possible embodiment of the principle of FIG. 2.

According to FIG. 4, the control device 2 receives a user name and an associated password from the user 11 in a step S21. The corresponding specifications can be submitted for example via the input device 17. Automated submission of the specifications—for example by connecting a suitable memory to the control device 2—is also possible.

The entered data corresponds to the initial data D and also to the identification data. In a step S22, the control device 2 therefore transmits the user name and the password to the corresponding computer 14 of the computer cluster 13. In a step S23, the control device 2 receives the authorization data D′. Steps S21 to S23 of FIG. 4 accordingly correspond to steps S1, S3 and S4 of FIG. 2. No equivalent needs to be present for step S2 of FIG. 2.

In a step S24, the control device 2 checks whether the transmitted authorization data D′ allows an access to internal data of the control device 2, in particular to the program memory 5 and/or the data memory 4. If this is not the case, the procedure of FIG. 4 is terminated. The access is therefore denied.

Otherwise, in a step S25, the control device 2 receives a command B from the user 11. In a step S26, the control device 2 checks whether the submitted command B was a command for accessing the internal data of the control device 2 or a command for terminating accesses to the internal data of the control device 2 (logout). If the command B was a command for terminating the accesses, the procedure of FIG. 4 is likewise terminated. Otherwise, in a step S27, the control device 2 grants the user 11 the corresponding access. It then returns to step S25.

The authorization data D′ of step S23 can—analogously to step S14 of FIG. 3—include restriction data which limits the access to the internal data of the control device 2. It is possible for example that only read access to data, only write access to data, or both read and write access to data is allowed. It is furthermore possible to permit access only to the data memory 4, only to the program memory 5, or to both the data memory 4 and the program memory 5. Other restrictions can also be implemented as necessary.

If the authorization data D′ includes corresponding restriction data, a step S28 is additionally provided which is arranged between steps S26 and S27. In step S28, the control device 2 checks whether the access requested in step S25 complies with the restrictions according to the restriction data. Depending on whether this is the case or not, step S27 is executed or not.

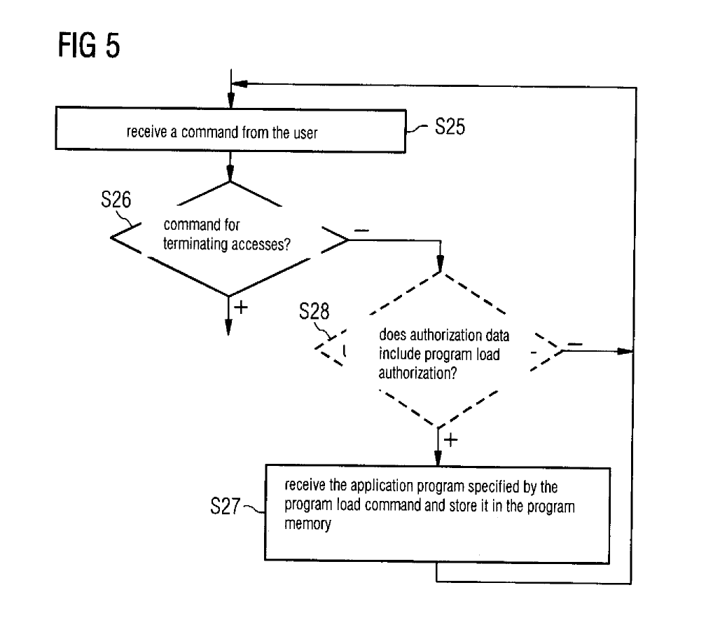

The procedure of FIG. 4 is explained once more below in connection with FIG. 5 in a special embodiment of the restriction.

Within the framework of FIG. 5 it is assumed that the authorization data D′ received in step S23 may include a program load authorization, i.e. may grant the user lithe right to access the program memory 5 for writing. It is furthermore assumed that the user 11 has submitted a corresponding program load command in step S25.

In this case the control device 2 checks in step S28 according to FIG. 5 whether the authorization data D′ includes the corresponding load authorization. If this is the case—and only then—the control device 2 receives, in step S27, the application program 10 specified by the program load command and stores it in the program memory 5. Prior to this, in accordance with the procedure explained in connection with FIG. 3, the application program 10 can if necessary be checked with the aid of identification data assigned to the application program 10.

In principle the application program 10 can be made available from an arbitrary source. In particular it is possible according to FIGS. 1 and 5 that as a result of the program load command the control device 2 will receive the application program 10 from one of the computers 14 of the computer cluster 13 via the connection device 8 and the computer network 12 will retrieve it from there, for example.

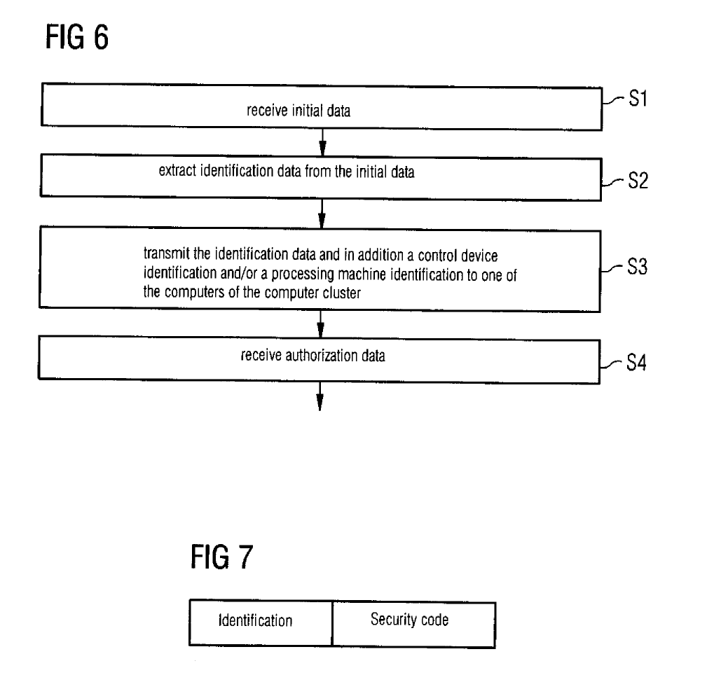

It is possible to perform the above-described procedures as they are. According to FIG. 6, however, the control device 2 preferably transmits a control device identification and/or a processing machine identification to the corresponding computer 14 of the computer cluster 13 together with the identification data. The control device identification uniquely identifies the control device 2. It is therefore assigned individually to the respective control device 2 only—even if there is a plurality of control devices 2 of identical design. This applies analogously to the processing machine identification. The corresponding identifications can be taken into account on the computer cluster 13 side in the course of ascertaining the authorization code D′.

The respective identification can include—see FIG. 7—a suitable security code, for example an electronic certification seal or an electronic signature.

The present invention has many advantages. In particular, access rights to the control device 2 can be administered dynamically and centrally in the computer cluster 13 in a simple and secure manner. No special communication mechanisms are required. Communication in accordance with conventional rules for secure communication is sufficient. Communication rules of this type are widely established, in online banking for example, and are also known in the form of the https protocol. Users 11 may only perform the actions for which they have authorization. Manipulations of application programs 10 can be virtually ruled out. Confidential data can be accessed by authorized users 11 only. Actions can be embodied such that they can be authenticated, logged and traced.

Only the operation of the control device 2 has been explained in detail hereinabove. The measures necessary on the part of the computer cluster 13 have not been explained in greater detail. They must be implemented nonetheless. For example, the corresponding assignment of the security information to the application program 10 must be ensured on the computer cluster 13 side. However, this is not the subject of the present invention, but a prerequisite for the present invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for operating a processing machine controlled by a control device, comprising:
receiving with the control device directly from a user of the processing machine a user identification and an associated password via an input device assigned to the control device,
transmitting with the control device the user identification and the associated password to a computer of a computer cluster which has a connection to a computer network,
receiving with the control device user-specific authorization data from the computer or from another computer of the computer cluster,
checking with the control device whether the user-specific authorization data allows access to internal data of the control device, and
depending on a result of the checking, causing the control device to allow or deny the user access to the internal data of the control device.

2. The method of claim 1, wherein the user-specific authorization data includes user-specific restriction data limiting access to the internal data, and wherein when the user-specific authorization data allows access to the internal data, the control device limits access to the internal data commensurate with the user-specific restriction data.

3. The method of claim 2, further comprising:
receiving with the control device from the user a program load command,
checking with the control device whether the user-specific restriction data includes a program load authorization, and
depending on the result of the checking, receiving with the control device an application program specified by the program load command for controlling the processing machine, and storing the received application program in a program memory of the control device.

4. The method of claim 3, wherein based on the program load command, the control device receives the application program from the computer, from the other computer or from a third computer of the computer cluster via the connection to the computer network.

5. The method of claim 3, further comprising:
receiving with the control device security information for the application program in addition to the application program,
transmitting with the control device the security information to a computer of the computer cluster via the connection to the computer network,
receiving with the control device from a computer of the computer cluster program-specific authorization data,
checking with the control device whether the program-specific authorization data allows execution of the application program, and
depending on the result of the checking, allowing or denying the control device to store the application program.

6. The method of claim 5, wherein the program-specific authorization data includes program-specific restriction data limiting execution of the application program, and wherein when the program-specific authorization data allows execution of the application program, the control device controls the processing machine only in accordance with the program-specific restriction data.

7. The method of claim 5, wherein the control device transmits to the computer of the computer cluster via the connection to the computer network together with the security information a control device identification which uniquely identifies the control device, or a processing machine identification which uniquely identifies the processing machine, or both a control device identification and a processing machine identification.

8. The method of claim 1, wherein the control device transmits to the computer of the computer cluster via the connection to the computer network together with the user identification and the password a control device identification which uniquely identifies the control device, or a processing machine identification which uniquely identifies the processing machine, or both a control device identification and a processing machine identification.

9. The method of claim 7, wherein at least one of the control device identification and the processing machine identification includes a security code.

10. A system program embodied in a non-transitory medium and comprising machine-readable machine code, which when read into memory of a control device of a processing machine and directly executed by the control device, causes the control device of the processing machine to:
receive directly from a user of the processing machine a user identification and an associated password via an input device assigned to the control device,
transmit the user identification and the associated password to a computer of a computer cluster which has a connection to a computer network,
receive user-specific authorization data from the computer or from another computer of the computer cluster,
check with the control device whether the user-specific authorization data allows access to internal data of the control device, and
depending on a result of the check, allow or deny the user access to the internal data of the control device.

11. A control device for a processing machine, wherein the control device is programmed with the system program of claim 10.

12. A processing machine comprising the control device of claim 11.

13. The processing machine of claim 12, wherein the processing machine is embodied as a machine tool, as a production machine or as an industrial robot.

14. The method of claim 8, wherein at least one of the control device identification and the processing machine identification includes a security code.
